(19) United States
(12) Patent Application Publication
(10) Pub. No.: US 2023/0260362 A1
(43) Pub. Date: Aug. 17, 2023

(54) COMPUTER SYSTEM, METHOD AND COMPUTER PROGRAM PRODUCT

(71) Applicant: ODDSCRAFT AB, Stockholm (SE)

(72) Inventors: Robin JAKOBSSON, Stockholm (SE); Daniel ANDERSSON, Stockholm (SE)

(21) Appl. No.: 18/007,038

(22) PCT Filed: Jul. 29, 2020
(86) PCT No.: PCT/EP2020/071426

§ 371 Date: Jan. 26, 2023

(51) Int. Cl. G07F 17/32

(52) U.S. Cl. CPC G07F 17/323; G07F 17/3262; G07F 17/3244; G07F 17/3288

(57) ABSTRACT

A computer system (100, 200) for calculating odds (107, 207) for a selection (105, 205) of at least one of a plurality of different predefined options (106-1-106-n), the computer system (100, 200) comprising an odds calculator (101, 201) comprising a first communication interface (102, 202) and a processor (103, 203) coupled to the first communication interface (102, 202), the first communication interface (102, 202) being configured to receive the selection (105, 205) and to provide the selection (105, 205) to the processor (103, 203), wherein the processor (103, 203) is configured calculate the odds (107, 207) for the selection (105, 205) based on individual probabilities of the single options (106-1-106-n) included in the selection (105, 205), and to output the calculated odds (107, 207) via the first communication interface (102, 202). Further, a respective method and a respective computer program product is provided.

### TECHNICAL FIELD

The invention relates to a computer system for calculating odds for a selection of at least one of a plurality of different predefined options. Further, the invention relates to a respective method.

### BACKGROUND

Although applicable to any system that allows placing bets, the present invention will mainly be described in conjunction with betting regarding sports events.

In today's sportsbook platforms, a user may usually select so called markets. A market in this regard refers to a predefined outcome or a group of predefined outcomes. Further, a betting market may comprise different pre-defined outcomes, which a user may select to bet on. However, the user may only choose a pre-defined outcome but not modify the pre-defined outcomes. For a specific sportsbook soccer event, a market “match winner” may e.g. provide the outcomes “home”, “draw”, and “away”. The market “match winner” with the selection “home” would therefore comprise all results that result in a match win for the home team. The market “match winner” with the selection “draw” would therefore comprise all results where both teams have the same score. The market “match winner” with the selection “away” would therefore comprise all results that result in a match win for the guest team, that is “away” from his home stadium.

There exist several problems with traditional sportsbook platforms:

Problem 1

Sportsbook platforms of today provide many opportunities to bet on the outcome of various aspects of a wide range of sporting events, with each event having many different predetermined markets available, which vary depending on the event. A user may only select one outcome within a market and place a bet on that selection as a single bet at the predetermined odds offered by the sportsbook platform. If a user would like to place a bet on more than one outcome in the same market, they must place a separate single bet on each outcome. Furthermore, the odds offered by the sportsbook operator always include a margin, so the user would pay the margin on each of the single bets placed. Therefore, this current offer is unsatisfactory for the user as they cannot incorporate all of the outcomes within a market that they would like to cover, into a single bet and only pay the margin once.

Problem 2

The markets offered by sportsbook platforms on any event will contain any number of predefined possible outcomes with predetermined odds. However, there are many examples where predefined outcomes by default incorporate a far wider scope of possible outcomes, which is reflected in the odds offered. This is also not optimal for the user as they will pay for something that they do not believe will happen, in order to cover what they do believe will happen.

Therefore, the offering provided by sportsbook platforms currently limits the user's options and does not allow the user to select options freely, or the sportsbook platform to meet discerning user demands for more flexibility and customisation.

Accordingly, there is a need for a more flexible system for selecting predicted outcomes in the offering of a sportsbook platform.

### SUMMARY OF THE INVENTION

The above stated problems are solved by the features of the independent claims. It is understood, that independent claims of a claim category may be formed in analogy to the dependent claims of another claim category.

Accordingly, it is provided:

A computer system for calculating odds for a selection of at least one of a plurality of different predefined options, the computer system comprising an odds calculator comprising a first communication interface and a processor coupled to the first communication interface, the first communication interface being configured to receive the selection and to provide the selection to the processor, wherein the processor is configured to calculate the odds for the selection based on individual probabilities of the single options included in the selection, and to output the calculated odds via the first communication interface.

Further, it is provided:

A method for calculating odds for a selection of at least one of a plurality of different predefined options, the method comprising receiving the selection, calculating the odds for the selection based on individual probabilities of the single options included in the selection, and outputting the calculated odds.

Further, it is provided:

A computer program product comprising instructions which, when the program is executed by a computer, cause the computer to carry out the method of any one of the method related claims.

The present invention is based on the finding that providing a user with a number of predefined markets, from which a user may only select one of the predefined outcomes, i.e. options in terms of the present invention, limits the possible options a user may select for a bet.

The present invention therefore provides the computer system that allows for freely defining any selection of possible outcomes within a market, i.e. options, and provides the re-calculated odds for a single bet, i.e. selection, containing the selected outcomes as (e.g. selected outcome 1, or selected outcome 2, or selected outcome 3). The computer system therefore allows for example the user to create a single bet that includes more than one of the possible outcomes, i.e. options, in that market, instead of only one.

In the context of this invention, the following term definitions are applied:

“Event” means a singular match, race, fight, or other such contest in which there is an element of competition, whether sporting, political, gaming or otherwise. Many hundreds of events can potentially be featured on a sportsbook platform on a daily basis, and different aspects of the event can be bet upon by its users.

“Market(s)” are created by a sportsbook platform by defining multiple options for what may occur in relation to different aspects of an event. Examples of typical markets could for instance be the number of corners that will take place in a soccer match, or the number of rebounds that will be scored by an individual player in a basketball match. A market may offer users any number of options to bet on, but there is not currently a system available to sportsbook platforms that allows users to select more than one option in a market and combine them in a single bet.

“Single Bet” is a term used to describe a bet placed on one selection with predefined odds in a market. Winnings are calculated as the value of the bet multiplied by the odds.

“Combination Bet” is a term used to describe a bet placed on multiple selections with predefined odds on independent markets and/or events, where the odds are multiplied together to arrive at the “Accumulated Odds” and in order to win the combination bet, each of the individual selections must be successful.

With the present invention in a combination bet that includes bets from at least 2 events, the multi selection for the user can also be applied, since the possible outcomes in a traditional combination bet are 0, to n correct bets, where n represents the number of events included in the combination bet. Hence, with the present invention a market may be created with mutually exclusive bet options. The traditional way of offering this market is by asking the question: “will you get all bets correct in your combination bet?”, with the only answer to that question with a bet option to select is “Yes”. Since it's possible with the present invention to create a combination bet as a market with up to (n+1) mutually exclusive options, the question “How many correct bets will you get?”, and the answers/bet options being 0, 1, . . . , n—multi selection could also be applied to combination bets.

“Selection” is the group of option(s) that a user decides to add to a single bet or combination bet.

“Odds” is the price offered by the sportsbook platform for an option, converted from the probability of such an outcome happening.

“Sportsbook Platform” is the interactive system, such as a website or mobile application made available by licensed gambling operators to users for the purpose of placing bets on events against “the house”. The computer system according to the present invention may be implemented into such a “sportsbook platform” or may be part of such a “sportsbook platform” as an additional component.

“user” is a member of the public who may deposit money, real money or play money, and place bets. Usually a user will have signed up and created an account on the sportsbook platform in order to deposit money and place bets.

“Insurance” can be offered to users by the sportsbook platform. It allows users to select an option that would return to them a predefined value if that selected option were to occur. This may be a partial or full refund of the user's bet, or any other value or award that is offered at the discretion of the sportsbook platform.

The present invention can be applied to any market (on any event) that contains more than two predefined outcomes to select from. Such an event may e.g. be a sports event, like a soccer match. It is however understood, that the present invention is not limited to soccer matches. The present invention may be applied to any kind of event, like sports events, e-sports events and also non-sports events, that a user may want to place bets on.

In soccer matches two teams play against each other. A market within the event of a soccer match may refer to the possible final score/result of the match, e.g. 0:0, 1:0, 0:1, etc. Each being a possible outcome. A market may also relate to the performance of a specific player, e.g. to score 0, 1 or more goals in a specific match. Other examples of events may also refer to running contests of humans, animals, vehicles, to fighting events, like boxing or other martial arts events or similar. In such cases the available markets may e.g. refer to a ranking, a winning time, or winning round, or any other aspect of the respective event. Further, the event does not need to comprise multiple participants. An event may for example refer to a single person performing a specific act or sport. For example, a bet may be placed for a single person performing weight lifting or running. The single options provided in a respective market may therefore also refer to different maximum weights that the person may lift or to running times that the person may need to run a specific distance. Another related example is for example football players to score 0, or 1 or more than 1 goal in a specific match. In this case, the match would be the event, while a respective market would provide the options of the number of goals the respective player would score. It is understood, that any football or soccer related example may be applied to any other sport.

To provide the ability to freely define any selection of possible options in a market, the computer system provides the odds calculator.

The odds calculator comprises a first communication interface to receive a selection of respective options. It is understood, that the first communication interface may be a hardware interface, like e.g. an Ethernet interface, or a program interface, like a specific API, or a combination of both. Consequently, the processor of the odds calculator may also be implemented as hardware or a computer program. For example, the odds calculator may be provided as a service on a server that is accessible via a network, like the internet. In an alternative embodiment, the odds calculator may e.g. be implemented in the program code of a website, e.g. as JavaScript application. Such an odds calculator may e.g. retrieve the odds of the single options via the internet from a respective server and perform the respective calculations on the user's computer.

The selection therefore represents a group of options for which the overall odds are to be calculated. It is understood, that the selection may only comprise a single option, if the user does not select more than one option to be included in the selection.

In embodiments, the outcomes refer to different possibilities within the same market.

Traditional sportsbook platforms do not allow a user to combine a number of possible outcomes from the same market. The user can only bet for one predefined outcome within a market, which by default means they are betting against all other predefined outcomes in that market.

In contrast, with the present invention, the user has total freedom to formulate his own selection of possible options, i.e. outcomes, in a market, which are then all combined in an “OR” fashion. This means that the bet is successful if any of the outcomes the user selected for his bet is correct.

The selection is provided via the first communication interface to the processor of the odds calculator. In the processor the overall odds for the selection are re-calculated based on the individual probabilities of the single options included in the selection, along with a one-time margin for the sportsbook operator on the customised single bet.

Therefore, with the present invention, the user may include all outcomes that he would like to cover in a market, into a customized single bet and only pay the applied margin for the sportsbook operator once, creating even more value for the user.

In known betting systems, if a user wants to bet on more than one outcome in the same betting market, several consecutive bets must be performed. Since it is time-consuming and tedious to select each outcome, and after that go to the bet slip and enter stakes for each outcome and then confirm all bets, many users refrain from even attempting to perform this procedure. This situation is even more critical in a live betting environment, where users must make quick decisions and odds frequently change. Placing a series of live bets on different outcomes within the same market, at the odds a user initially intended to bet on, is often impossible. By allowing users to create their own selection of bet options and then placing a single bet based on the calculated odds for the selection to cover all selected outcomes, the present invention vastly reduces time consumption for users, especially when using a full-time exact score matrix (see FIG. 4), but also for any other betting market.

The more granular the bet options within a betting market are—the higher flexibility and freedom of choice is given to the user by the present invention. In soccer, for example, the most granular match-result related bet options, is the exact score market, where each bet option represents one single end result. Since the present invention now allows users to place bets on any combination of possible outcomes within betting markets, users can create a nearly infinite choice of unique single bets to their personal preference. Since the exact score matrix contains the most granular elements of a sports match, most predefined markets related to exact score, can be reproduced in the exact score market with the functionality provided by the present invention.

In addition, due to the individual tailor-made creation of bet options, the present invention also solves a problem that sportsbook users are partly unaware of (as identified in Problem 2 above):

Many popular pre-defined markets theoretically include a wide range of possible outcomes, which increases the probability, which in turn devalues the price offered. This means that users are often paying to include outcomes in their bet selections that they don't really want, or do not believe will happen. Looking at bet selection odds as commodities, the present invention provides freedom of choice to decide exactly what product should be sold/bought to a price that is accepted by the seller/buyer. The users of the present invention don't have to pay for something they don't want to pay for. Therefore, users are also in a position to create more value by removing the outcomes that form part of the predefined market, that they do not believe will happen. The present invention therefore has a positive impact on fulfilment of discerning customer demands.

Finally, since the user is able to create any combination of options from any market with the present invention, space for displaying markets may be reduced. Basically, only the most granular market is needed to display in order to offer for any bet related question, while any combination of options within each such market can be constructed by the user. The exact score for full time results usually is the most space saving market. Also, for example with a 3-way market like “Home/Draw/Away”, the present invention allows reducing by 80 percent the space of displayed markets.

This is because, if a sportsbook wants to display the market “Home/Draw/Away” for full time result in a soccer match, most likely also the possible other markets related to this market should be displayed. The markets in this case would be:
“Home/Draw/Away” (3 options market)—this is the most granular
“Draw no bet” (2 options market)—betting on home or away, with the draw option taken out of the equation (stake is paid back if a draw result)
“Home no bet” (2 options market)—betting on draw or away, with the home option taken out of the equation (stake is paid back if a home result)
“Away no bet” (2 options market)—betting on home or draw, with the away option taken out of the equation (stake is paid back if a away result)
“Double Chance” (3 options market)—betting on 2 options (home/draw, away/draw, home/away)

With the invention's functionality, only the first market (“Home/Draw/Away”) needs to be displayed, while the options in the 2^{nd} to 5^{th} market easily can be constructed by the user.

The point is, for a 3way market, the displayed space when offering the above bet options is reduced by about 80%. For markets with more options than 3, that proportion of saved space is higher than 80%.

The time consumed on finding a preferred bet option correlates highly with the proportion of saved space of display.

Further embodiments of the present invention are subject of the further subclaims and of the following description, referring to the drawings.

In an embodiment, the computer system may comprise a probability database comprising a probability for every one of the predefined options, wherein the probability database may be integrated in the odds calculator, or wherein the probability database may be communicatively coupled to the odds calculator.

The odds calculator uses the probabilities of all individual options as the basis for calculating the odds for a specific selection of options.

To this end, the individual probabilities need to be provided. The probability database may therefore store such probabilities for use by the processor of the odds calculator. As alternative, the probabilities may be instantly derived from the selected market's odds. The probability database may be integrated into the odds calculator or may be provided as separate entity. It is understood, that in this regard the term “database” refers to any structure that may hold the respective values. Accordingly, the probability database may e.g. be provided as a respective data structure in the memory of the processor, or as a program that is executed on the processor and provides the functionality of a database, e.g. an API to access the stored data. Any other type of data storage that is accessible by the processor may also be used as database.

If the database is provided as a separate entity, the processor may e.g. access the database via the first communication interface e.g. over a network like a local area network or the internet.

Further, it is understood, that the probability database may provide predefined or pre-stored probabilities. However, the probability database may also be dynamically updated to provide real-time or near-real-time probabilities.

To this end, the computer system may further comprise a probability source that may be coupled to the probability database to update the content of the probability database. Such a probability source may e.g. be a user terminal or user interface that allows providing updated probability values. As alternative or in addition, the probability source may also be an automatic source, that automatically determines probabilities.

In a further embodiment, the computer system may comprise a user interface configured to display the predefined options to a user and to receive user instructions that indicate the options to be added to the selection. The user interface to this end may comprise a second communication interface coupled to the first communication interface, wherein the user interface may be configured to provide the selection to the odds calculator and to receive the calculated odds for the selection via the second communication interface, and e.g. to display the received odds for the selection to the user.

The user interface may be provided in part e.g. as a web site or computer program that displays the possible options on a display device, e.g. a user's smartphone or computer screen, and allows a user to select individual ones of the displayed options. It is understood, that the user interface may be provided remote to the odds calculator and may be communicatively coupled to the odds calculator.

In an exemplary embodiment, the computer system may provide its functionality via a network. In such an embodiment, the odds calculator and the user interface may e.g. be implemented as so called back-end on a server and front-end on a user's device. The probability database may also be provided as a service in such a computer system. As alternative, the odds calculator may e.g. be provided in combination with the user interface, e.g. as a website with respective JavaScript code or a (progressive) web app. The odds calculator may then access the probability database via a network.

In another embodiment, the user interface may be configured to display for every one of the predefined options an individual probability and/or the individual odds, and after receiving the calculated odds for the selection to display the odds for the selection.

The user interface may, as explained above, be implemented as a computer program or a web site and may therefore retrieve information from the odds calculator and/or the probability database.

The user interface may be configured to update the selection odds in real time, i.e. after every modification of the selection by the user. To this end, the user interface may transmit every new selection that is created by the user e.g. by adding or removing an option from the selection to the odds calculator and retrieve the respective odds from the odds calculator.

In a further embodiment, the user interface may be configured to retrieve and/or receive the individual probabilities and/or the individual odds for every one of the predefined options via the second communication interface from the probability database.

It is understood, that the odds calculator may provide the user interface with data from the probability database or that the user interface may directly access the probability database to retrieve the individual probabilities or odds.

The odds calculator may provide a so-called push-service to the user interface, that allows the odds calculator to “push” new odds or probabilities to the user interface when available. In addition, or as alternative, the user interface may perform so called polling, and repeatedly retrieve the odds and/or probabilities

In another further embodiment, the selection may comprise a number, i.e. one or more, of options that represent a bet and zero or more options that represent an insurance.

The terms bet and insurance refer to different modes of operation of the single options a user may select. If a user selects an option as a bet, if the user wins the bet, he will be rewarded with the stake he placed multiplied by the odds of the respective option. If a user selects an option as an insurance, if the result of the event is the insurance option, the user will be rewarded with the stake he placed, i.e. the stake will be returned to the user. An insurance as described here is a full insurance, i.e. giving the full stake back, which is the same as a voided bet. However, the present invention is not limited to the case of a full insurance. In other embodiments, an insurance may refer to a “half insurance”, giving half the stake back, or “double insurance”, giving the doubled stake back. Basically, any number from zero and up times the stake is possible to get back if the insured option occurs.

The processor may be configured to calculate the odds for the selection as a function of the selected bet option's probabilities and a margin. The processor may also adjust the odds due to insured options as a function of the selected bet option's probabilities and a margin and also the selected insurance options and the level of insurance.

In an embodiment, the processor may calculate the odds by calculating an overall probability for the selection, i.e. for all options of the selection, as the result of the sum of the probabilities of the options that represent a bet divided by the difference of 1 and the sum of the probabilities of the options that represent an insurance, and by dividing the difference of 1 and a predefined odds margin by the calculated overall probability. Other mathematical operations may be used to calculate the odds in other embodiments.

In a further embodiment, the options may refer to possible results of an event with an unknown result, especially to a sports event with an unknown result.

As explained above, the present invention may especially be applied to betting systems. Therefore, the options may refer to unknown results of events, i.e. events that will happen in the future or are currently happening. Such events may typically be sports events, but any other type of event, like e.g. elections, is also possible.

### BRIEF DESCRIPTION OF THE DRAWINGS

For a more complete understanding of the present invention and advantages thereof, reference is now made to the following description taken in conjunction with the accompanying drawings. The invention is explained in more detail below using exemplary embodiments which are specified in the schematic figures of the drawings, in which:

FIG. 1 shows a block diagram of an embodiment of a computer system according to the present invention;

FIG. 2 shows a block diagram of another embodiment of a computer system according to the present invention;

FIG. 3 shows a diagram of a possible user interface in an embodiment of a computer system according to the present invention; and

FIG. 4 shows a flow diagram of an embodiment of a method according to the present invention.

In the figures like reference signs denote like elements unless stated otherwise.

### DETAILED DESCRIPTION OF THE DRAWINGS

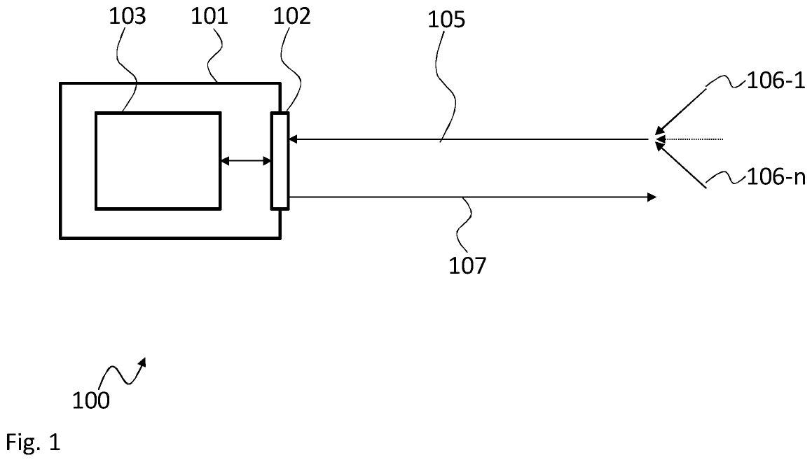

FIG. 1 shows a block diagram of a computer system 100. The computer system 100 serves for calculating odds 107 for a selection 105 of at least one of a plurality of different predefined options 106-1-106-n, as already explained above and further explained below.

The computer system 100 comprises an odds calculator 101. The odds calculator 101 comprises a first communication interface 102 and a processor 103, that is coupled to the first communication interface 102. It is understood, that the processor 103 may be implemented as any type of program, computer readable instructions or the like. Such a processor 103 may be executed by the processing unit or CPU of a computer, e.g. a server. Further, the processor 103 may be implemented at least in part as hardware, like e.g. a CPU, a controller or the like. It is understood, that the computer system may further comprise a memory coupled to the processor 103 that stores computer readable instructions that cause the odds calculator 101 to perform the required functions.

The first communication interface 102 may e.g. be provided as a software interface, like e.g. an API or callback function or the like. As alternative or in addition, the first communication interface 102 may at least in part be provided as a hardware interface, like e.g. a network interface. The first communication interface 102 in one embodiment may e.g. be provided as a combination of a network interface and an API that may be accessed via the network interface.

The first communication interface 102 receives the selection 105 and provides the selection 105 to the processor 103 for calculation of the odds 107.

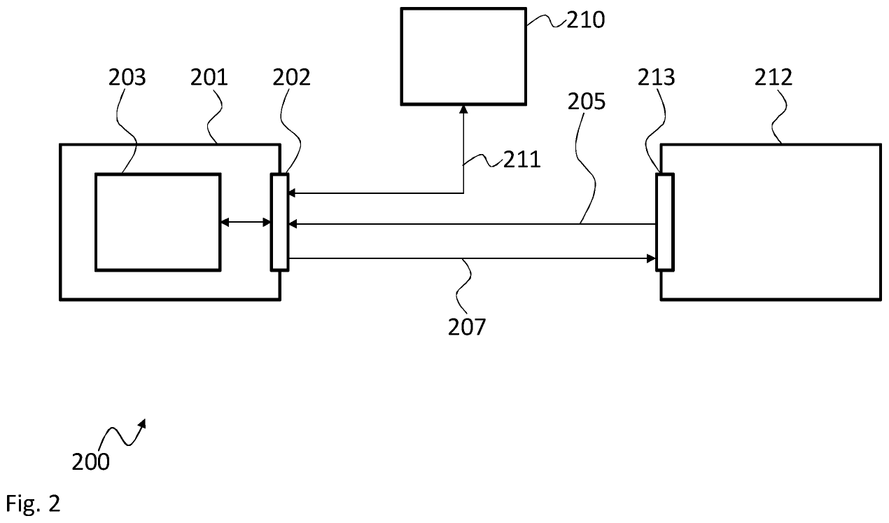

The processor 103 calculates the odds 107 for the selection 105 based on individual probabilities of the single options 106-1-106-n that e.g. a user included in the selection 105. After calculating the odds 107 the processor 103 outputs the calculated odds 107 via the first communication interface 102, e.g. to a user interface as may be seen in FIG. 2.

FIG. 2 shows a block diagram of another computer system 200. The computer system 200 is based on the computer system 100. Therefore, the computer system 200 also comprises an odds calculator 201. The odds calculator 201 comprises a first communication interface 202 and a processor 203. The explanations above regarding the odds calculator 101 apply analogously to the odds calculator 201 of the computer system 200.

The computer system 200 further comprises a probability database 210 that is coupled via the first communication interface 202 to the processor 203. The probability database 210 stores a probability 211 for every one of the predefined options and may provide the stored probabilities 211 to the processor 203. The probability database 210 as shown is arranged external the odds calculator 201. As alternative, the probability database 210 may also be integrated in the odds calculator 201.

The computer system 200 further comprises a user interface 212 that displays the predefined options to a user and receives user instructions that indicate the options to be added to the selection 205. For communication with the odds calculator 201, the user interface 212 comprises a second communication interface 213. It is understood, that the above-presented explanations regarding the first communication interface 102 also apply analogously to the second communication interface 213.

The user interface 212 after receiving the selection 205 from e.g. a user, provides the selection 205 to the odds calculator 201 and receives the calculated odds 207 for the selection 205 via the second communication interface 213. It is understood, that the odds 207 may then be displayed to the user and the user may accept or finalize his bet or change the selection 205.

The user interface 212 may display for every one of the predefined options an individual probability 211 and/or the individual odds. These individual probabilities 211 and/or individual odds may be provided by the odds calculator 201 to the user interface 212.

As alternative, the user interface 212 may also to retrieve and/or receive the individual probabilities and/or the individual odds for every one of the predefined options via the second communication interface 213 from the probability database 210.

In applications of the computer system 200 or the computer system 100, the selection 205 may comprise a number of options that represent a bet and zero or more options that represent an insurance. The terms bet and insurance are explained further above. The options 106-1-106-n may refer to possible results of an event with an unknown result, especially to a sports event with an unknown result.

The processor 103, 203 may calculate the odds 107, 207 for the selection 105, 205 by calculating an overall probability for the selection 105, 205 as the result of the sum of the probabilities of the options that represent a bet divided by the difference of 1 and the sum of the probabilities of the options that represent an insurance, and by dividing the difference of 1 and a predefined odds margin by the calculated overall probability.

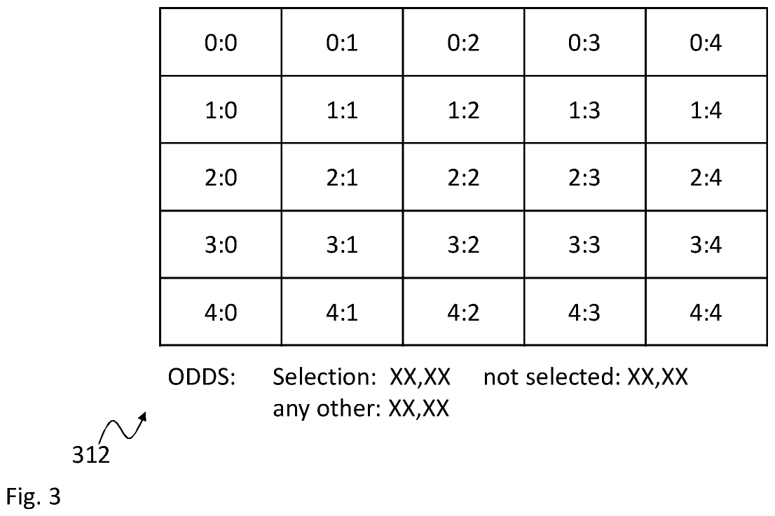

FIG. 3 shows a possible user interface 312, especially a possible graphical representation of a user interface 312, in an embodiment of a computer system 100, 200. The user interface 312 is an exemplary user interface for a soccer betting system. The user interface 312 shows a 5×5 table, where the first column comprises the values from top to bottom: 0:0, 1:0, 2:0, 3:0, 4:0. The second column comprises the values from top to bottom: 0:1, 1:1, 2:1, 3:1, 4:1. The third column comprises the values from top to bottom: 0:2, 1:2, 2:2, 3:2, 4:2. The fourth column comprises the values from top to bottom: 0:3, 1:3, 2:3, 3:3, 4:3. The fifth column comprises the values from top to bottom: 0:4, 1:4, 2:4, 3:4, 4:4. It is understood, that in this exemplary table, the values represent possible results of a soccer match. Therein the first number refers to the goals of the “home” team, and the second number to the goals of the “guest” team. The diagonal from the top left to the bottom right represents the draw results, where both teams score the same number of goals.

Below the table, different odds are shown. First, the odds for the selection are shown, second the odds of all not-selected options are shown. Finally, the odds for the combination of all other options, i.e. ranges not shown in the table, are shown. It is understood, that the shown exemplary user interface 312 is just a schematic view. Further, it is understood, that any other adequate representation may be used.

In an exemplary use case, a user may be browsing around in a standard sportsbook of a betting system and there finds the market “Match winner” with the options “Home/Draw/Away”. He wants to bet on the home team to win. He would like to insure his bet against the case of the match ending a draw. He can't find that specific pre-defined market, Draw No Bet. Therefore, he may use the present invention to fill the cells he needs. He would therefore select 1:0, 2:0, 3:0, 4:0, 2:1, 3:1, 4:1, 3:2, 4:2 and 4:3 as “bet” options for his selection, and 0:0, 1:1, 2:2, 3:3, 4:4 as “insurance” options for his selection. In this case, the odds may be calculated as 1.56. The user may want to at least double his money. Therefore, he may now decide to deduct a few exact results that he does not really believe in anyway—4:4, 3:3, 2:2, 4:3, 4:2 and 4:1. His odds now may now e.g. be 2.04, and he may place his bet.

In another example, a user may want to bet on the same match, but on the number of goals. He may e.g. find the market “under 1.5 goals” and intend to bet on “under” to odds of 7.70. This pre-defined market would result in a selection of the fields showing 0:0, 1:0, and 0:1. In this example, the user will actually win even if his favorite home team loses with 0:1. The user may however not want to win if his team loses. With the present invention, the user may simply remove that option 0:1 from his selection. His odds may now instead be 10.6 and he may place his bet.

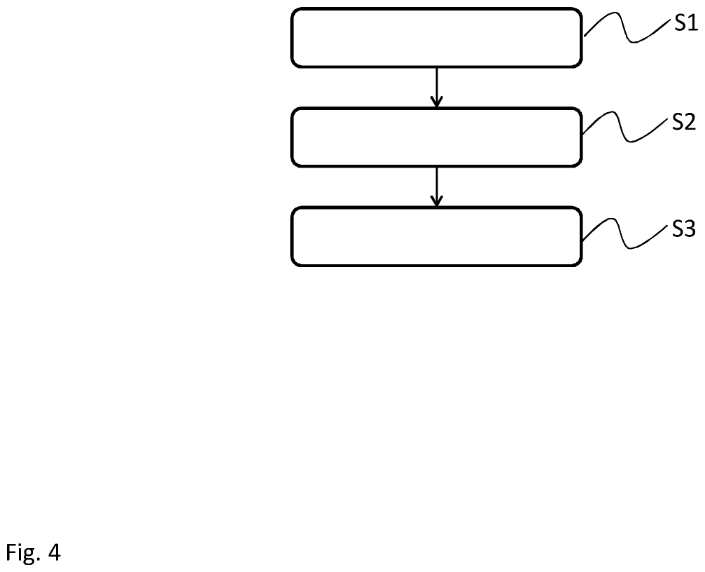

For sake of clarity in the following description of the method-based FIG. 4 the reference signs used above in the description of apparatus-based FIGS. 1-3 will be maintained.

FIG. 4 shows a flow diagram of an embodiment of a method for calculating odds for a selection 105, 205 of at least one of a plurality of different predefined options 106-1-106-n. the options 106-1-106-n may e.g. refer to possible results of an event with an unknown result, especially to a sports event with an unknown result.

The method comprises receiving S1 the selection 105, 205, calculating S2 the odds 107, 207 for the selection 105, 205 based on individual probabilities of the single options 106-1-106-n included in the selection 105, 205, and outputting S3 the calculated odds 107, 207.

The method may also comprise storing in a probability database 210 a probability 211 for every one of the predefined options 106-1-106-n as basis for the step of calculating the odds 107, 207.

Further, the method may also comprise displaying in a user display the predefined options 106-1-106-n to a user and receiving user instructions that indicate the options 106-1-106-n to be added to the selection 105, 205, and receiving the calculated odds 107, 207 in the user displays, which may then be displayed to e.g. to a user. In addition, for every one of the predefined options 106-1-106-n an individual probability 211 and/or the individual odds may be displayed. After receiving the calculated odds 107, 207 for the selection 105, 205, the user display may also display the calculated odds 107, 207 for the selection 105, 205.

In the user interface 212 individual probabilities and/or the individual odds for every one of the predefined options 106-1-106-n may be retrieved and/or received from the probability database 210 to be shown to the user. For example, the respective odds and/or probabilities may be shown in the respective cell of the table below the actual result or score.

If the present invention is used in a betting system, the selection 105, 205 may comprise a number of options 106-1-106-n that represent a bet and zero or more options 106-1-106-n that represent an insurance, wherein when calculating S1, the odds 107, 207 may be calculated for the selection 105, 205 by calculating an overall probability for the selection 105, 205 as the result of the sum of the probabilities of the options 106-1-106-n that represent a bet divided by the difference of 1 and the sum of the probabilities of the options 106-1-106-n that represent an insurance, and by dividing the difference of 1 and a predefined odds margin by the calculated overall probability.

Although specific embodiments have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

List of reference signs

| | |
|---|---|
| 100, 200 | computer system |
| 101, 201 | odds calculator |
| 102, 202 | first communication interface |
| 103, 203 | processor |
| 105, 205 | selection |
| 106-1-106-n | options |
| 107, 207 | odds |
| 210 | probability database |
| 211 | probability |
| 212, 312 | user interface |
| 213 | second communication interface |
| S1, S2, S3 | method steps |

1. Computer system for calculating odds for a selection of at least one of a plurality of different predefined options, the computer system comprising:
an odds calculator comprising a first communication interface and a processor coupled to the first communication interface,
the first communication interface being configured to receive the selection and to provide the selection to the processor,
wherein the processor is configured to calculate the odds for the selection based on individual probabilities of the single options included in the selection, and to output the calculated odds via the first communication interface.

2. Computer system according to claim 1, comprising a probability database comprising a probability for every one of the predefined options, wherein the probability database is integrated in the odds calculator, or wherein the probability database is communicatively coupled to the odds calculator.

3. Computer system according to claim 1, comprising a user interface configured to display the predefined options to a user and to receive user instructions that indicate the options to be added to the selection,
the user interface comprising a second communication interface coupled to the first communication interface,
wherein the user interface is configured to provide the selection to the odds calculator and to receive the calculated odds for the selection via the second communication interface.

4. Computer system according to claim 3, wherein the user interface is configured to display for every one of the predefined options at least one of an individual probability or the individual odds, and after receiving the calculated odds for the selection to display the odds for the selection.

5. Computer system according to claim 4, wherein the user interface is configured to at least one of retrieve or receive at least one of the individual probabilities or the individual odds for every one of the predefined options via the second communication interface from the probability database.

6. Computer system according to claim 1, wherein the selection comprises a number of options that represent a bet and zero or more options that represent an insurance,
wherein the processor is configured to calculate the odds for the selection by calculating an overall probability for the selection as the result of the sum of the probabilities of the options that represent a bet divided by the difference of 1 and the sum of the probabilities of the options that represent an insurance, and by dividing the difference of 1 and a predefined odds margin by the calculated overall probability.

7. Computer system according to claim 1, wherein the options refer to possible results of an event with an unknown result, especially to a sports event with an unknown result.

8. Method for calculating odds for a selection of at least one of a plurality of different predefined options, the method comprising:
receiving the selection,
calculating the odds for the selection based on individual probabilities of the single options included in the selection, and
outputting the calculated odds.

9. Method according to claim 8, comprising storing in a probability database a probability for every one of the predefined options as basis for the step of calculating.

10. Method according to claim 8, comprising displaying in a user display the predefined options to a user and receiving user instructions that indicate the options to be added to the selection, and receiving the calculated odds in the user displays.

11. Method according to claim 10, comprising displaying for every one of the predefined options at least one of an individual probability or the individual odds, and after receiving the calculated odds for the selection in the user display displaying the odds for the selection.

12. Method according to claim 11, comprising in the user interface at least one of retrieving or receiving at least one of the individual probabilities or the individual odds for every one of the predefined options from the probability database.

13. Method according to claim 8, wherein the selection comprises a number of options that represent a bet and zero or more options that represent an insurance,
wherein when calculating the odds are calculated for the selection by calculating an overall probability for the selection as the result of the sum of the probabilities of the options that represent a bet divided by the difference of 1 and the sum of the probabilities of the options that represent an insurance, and by dividing the difference of 1 and a predefined odds margin by the calculated overall probability.

14. Method according to claim 8, wherein the options refer to possible results of an event with an unknown result, especially to a sports event with an unknown result.

15. Computer program product comprising instructions which, when the program is executed by a computer, cause the computer to carry out an operation, the operation comprising:
receiving the selection,
calculating the odds for the selection based on individual probabilities of the single options included in the selection, and
outputting the calculated odds.

16. The computer program product of claim 15, wherein the operation comprises:
storing in a probability database a probability for every one of the predefined options as basis for the step of calculating.

17. The computer program product of claim 15, wherein the operation comprises:
displaying in a user display the predefined options to a user and receiving user instructions that indicate the options to be added to the selection, and receiving the calculated odds in the user displays.

18. The computer program product of claim 17, wherein the operation comprises:
displaying for every one of the predefined options at least one of an individual probability or the individual odds, and after receiving the calculated odds for the selection in the user display displaying the odds for the selection.

19. The computer program product of claim 18, wherein the operation comprises:
in the user interface, at least one of retrieving or receiving the at least one of individual probabilities or the individual odds for every one of the predefined options from the probability database.

20. The computer program product of claim 15, wherein the selection comprises a number of options that represent a bet and zero or more options that represent an insurance,
wherein when calculating, the odds are calculated for the selection by calculating an overall probability for the selection as the result of the sum of the probabilities of the options that represent a bet divided by the difference of 1 and the sum of the probabilities of the options that represent an insurance, and by dividing the difference of 1 and a predefined odds margin by the calculated overall probability.
